(19) United States
(12) Patent Application Publication
(10) Pub. No.: US 2004/0082718 A1
(43) Pub. Date: Apr. 29, 2004

(54) Elastic non-sticky surface gel material

(76) Inventors: Christopher Yuen Ming Chan, Hong Kong Sar (CN); Lin Tak Chan, Hong Kong Sar (CN)

Correspondence Address: ALIX YALE & RISTAS LLP, 750 MAIN STREET, SUITE 1400, HARTFORD, CT, 06103, US

(21) Appl. No.: 10/641,795

(22) Filed: Aug. 15, 2003

(30) Foreign Application Priority Data
Aug. 16, 2002 (GB) 0219164.1

(51) Int. Cl. C08L 53/00

(52) U.S. Cl. 525/88; 264/300; 264/331.11

(57) ABSTRACT

A styrene block copolymer is mixed with process mineral oil and includes a small amount of antioxidant which reduces surface stickiness in the finished material upon exposure to air. The material can simulate the touch and feel of human skin for a wide variety of applications.

### BACKGROUND OF THE INVENTION

The present invention relates to the manufacture of a soft, elastic gel material with a non-sticky surface. More particularly, although not exclusively, the invention relates to the provision of a non-sticky surface to an otherwise sticky elastic gel material made by compounding block copolymers with mineral process oil which as been widely used in the manufacturing of communication cables, sealants and toys. Typically, the copolymer used is a styrene-ethylene-butylene-styrene (SEBS) block co-polymer with the trademark “Kraton Thermoplastic Rubber” produced by Shell Chemical Co., or styrene-isoprene/butadiene styrene copolymer (SEEPS) marketed as Septon by High Performance Thermoplastic Rubber Kuraray Co., Ltd. In Japan.

The mineral oil used can be Shellflex 371 by Shell, or Duoprime 200 by Lyondell Lubricants.

The compounds produced are very soft, highly elastic and sticky.

These properties have been applied in the manufacture of a wide range of toys and other devices including crawling, tumkling and elastic memory function toys, in medical demonstration applications and in the falsification of prostheses. For example, reference is made to UK Patent No. 2,184,362B; U.S. Pat. No. 4,764,148; UK Patent No. 2,222,958; U.S. Pat. No. 4,884,989; UK Patent No. GB Patent No. 2,267,443; all of which disclose applications of such sticky elastic gel materials. U.S. Pat. No. 4,867,686; U.S. Pat. No. 5,035,758 disclose application of some other similar material which can be replaced by the present invention with improved results.

Although such soft sticky gel materials display many properties desirable in numerous applications, the surface stickiness can be an undesirable characteristic in others.

Another drawback of such materials is the bleeding of the mineral oil. This can cause staining when the products bear against a porous surface such as a paper surface for a prolonged period.

### OBJECTS OF THE INVENTION

It is an object of the present invention to overcome or substantially ameliorate at least one of the above disadvantages and/or more generally to produce a soft, elastic gel material having a relatively non-sticky surface.

It is a further object of the present invention to provide a method of producing a soft, elastic gel material having a relatively non-sticky surface.

### DISCLOSURE OF THE INVENTION

There is disclosed herein a styrene block copolymer mixed with process mineral oil and including a small amount of antioxidant to reduce surface stickiness upon exposure to air.

There is further disclosed herein a method of reducing surface stickiness of an elastic gel material, the method comprising the addition of a small amount of antioxidant during compounding of the elastic gel material.

Preferably the method further comprises melting the elastic gel material to assist compounding.

Preferably the method further comprises cooling the compounded gel material to room temperature.

Preferably the elastic gel material is a styrene block copolymer.

Preferably the styrene block copolymer is SEBS.

Alternatively, the styrene block copolymer is SEEPS.

Preferably the antioxidant is Iranox 1010 produced by Ciba.

Preferably the antioxidant is added into a mixture of the styrene block copolymer and process oil before melting same and cooling to room temperature.

Preferably the method includes forming the compounded material into a desired shape.

Preferably said forming might be by means of casting, injection moulding or blow moulding for example.

Preferably the method comprises achieving a desired surface texture by appropriate choice of mould material and mould surface finish.

Preferably, the method comprises exposing the surface of the formed gel material to a well ventilated atmosphere and maintaining air-flow over the surface.

Preferably the amount of antioxidant added to the other ingredients is from 1.2 to 2.0% by weight.

### DESCRIPTION OF THE PREFERRED EMBODIMENT

Basically, the polymer used is a class of block copolymer with an elastomeric block in the centre and a non-elastic block on each end. Styrene-ethylene-butylene-styrene (S-E-B-S) is one in the series with a strong centre elastic block. The physical. properties of the material can be modified by compounding with a variety of resins, plasticizers, fillers and other ingredients. The sticky elastomeric gel as described is achieved by compounding the polymer with a high percentage of process oil. The polymers used are the G series in the Kraton polymers such as G1650, G1651, G1657 or Scepton such as 4033, or 4055. The process oil is typically Shellflex 371 or Duoprime 200. The ratio of polymer to oil is typically in the range of 1:5 to 1:30.

An antioxidant is added to the sticky gel before or during compounding. The antioxidant used is typically Irganox 1010 produced by Ciba. This is a phenolic primary antioxidant for processing and long-term thermal stabilisation. It has been found quite by surprise that this additive achieves the desired effect of reducing surface-stickiness. The antioxidant is added into the mixture of the polymer and process oil before melting.

The method of manufacturing is fundamentally the same as making sticky gel. The added antioxidant is compounded in the melt that becomes a gel after cooling to room temperature. The gel is soft, highly elastic and slightly oily and sticky on the surface. After exposure to air, the surface of the gel becomes non-sticky.

The resulting surface properties depend on a number of factors including the polymer-to-process oil ratio, the concentration of the antioxidant, the quantity of air to which the gel is exposed and the flow rate of air over the surface. Other factors affecting the surface texture include the method by which the finished product is formed, such as by casting from a silicon mould, by injection or blow moulding etc. the grade of surface finish and the mould material itself also plays an important factor. The texture of the surface finish and the suitability to its application can be matched by selecting carefully the mould material and its surface finish.

The texture of the gel surface finish can be achieved, not only by proper design of the mould surface, but by addition of an appropriate amount of antioxidant. Antioxidant less than say 1.0% by weight of the total mixture may take a very long time to achieve a completely non-sticky surface. More than say 1.8% may result in a rougher surface over time. Also, the longer the material is exposed to air, the rougher the surface becomes.

The material surface remains tacky as long as that the surface is not exposed to air.

Furthermore, only the surface is non-tacky. Beyond the surface. That is inside the material, it remains tacky.

Further, if the material is cut and the newly cut surface is exposed to air, after a period of time, the surface becomes non-tacky.

The non-sticky surface gel has many applications including medical applications. The soft, elastic and non-sticky gel material resembles in many aspects the properties of human tissue and skin. Accordingly, the material can be used in the manufacture of prosthetic body parts such as ears, noses and breasts.

The compatibility of the material with other additives means that other properties can be readily achieved. In forming a prosthetic ear for example, the colour of the ear can be varied by adding suitable colour additives. Colour shading of a prosthetic ear can be achieved by painting. However, the paint would have to be specially synthesised such that elasticity of the paint would be similar to that of the gel material. Instead, a compatible dye can be added to the compounding materials.

The actual size and shape of the parts can be copied very accurately from a patient by modern laser scanning and rapid prototyping techniques.

Because of compatibility and acceptability of the material with other materials, its properties can be easily enhanced by adding other ingredients.

The following are two examples:

(i) The density of the compound can be adjusted by adding filler materials, such as calcium carbonate or metal fillings. This alters the hardness of the compound also. Such a compound is necessary when using the invented material for making articles for physical exercise when different hardness and elasticity is required.

(ii) By adding a small quantity of ultra-violet stabilizer (about 1%), the material is stable and not susceptible to degradation when exposed to ultra-violet light.

The material might also find application in medical training models. Resembling human tissue, the material might be used to form a model human arm or buttock where injection and blood transfusion training can take place.

Female breast models might be made of the present material for simulated abnormality detection.

It is well known that breast cancer is a very serious and potentially fatal disease. U.S. Pat. Nos. 4,134,218 and 4,867,686 disclose the usage of models to train for the detection of tumours. The models consist of an assembly of several parts. The essential two are the skin and the simulated adipose tissue. Materials suggested are polyvinyl for the skin and silicon gel for the tissue. The manufacturing process is rather complicated. The present non-sticky surface gel material meets all the properties required in the above patents. The manufacturing process involved is simply to cast the soft elastomeric material as disclosed herein into the desired shape. The choice of mould material and control of the surface finish adds to produce a human-like skin tissue assembly model. Simulated tumours can be made of any material such as cotton or styrene fibres, styrene-ethylene-styrene copolymer, or even cotton buds for example to simulate internal tumours. The manufacturing process is simple and in-expensive.

U.S. Pat. No. 4,401,492 discloses a method of making breast prostheses for use after mastectomy operations. The method is similar to the method described for making breast cancer detection models. Essentially, the prostheses are an assembly including a top and bottom film with a gelatinous resin filled in between to simulate the shape and mass of a breast. The manufacturing process is complicated. The present material might simply be moulded to achieve a superior prosthesis.

Soft elastomeric material has been used for making stress-relief articles for exercising of the palms and fingers. For example a ball-shaped article made with gelatinous material can be covered with stretchable cloth such as Lycra. The gelatinous materials used are dissolved PVC, elastomeric silicone and styrene copolymer-oil compounds. These elastomeric gels have an oily surface causing staining on clothes for example. The oily “bleeding” is overcome with a cover skin which can be very cumbersome in manufacture. The present non-sticky elastomeric material eliminates the use of the cover layer and is non-staining. When properly controlled compounding ingredients are used.

The non-sticky, soft, elastic and resilient properties of the present material are ideal for the manufacture of cushions. Moulded cushions might be made from the present material for disabled patients and people with specific positional/postural support needs. The cushions might have application in wheelchairs and special bed rests used in hospital beds.

As mentioned above, the properties of stickiness of gel material have been applied in the manufacture of toys. Some such toys are thrown against a wall and appear to “walk” down the wall. As the surface of the sticky material is oily, this can cause staining. This can be a drawback in some applications. The present soft, elastic non-sticky material resembles the soft, elastic nature of human tissue and therefore will have different applications. Careful selection of mould material can produce articles closely resembling the touch and feel of human skin-tissue construction. Factors contributing to the surface finish include the type of material used for making the mould—for example silicone rubber, steel, copper or other material, and the texture and finish on the mould surface and the control of the atmosphere during moulding and cooling.

This soft, elastic and fine touch feeling property of the invented material are very attractive for making playing products.

The very soft yet elastic nature are safe and have a lot of playing values for throw and catch products such balls. These can be solid, hallow and hallow balls filled with other material to give additional playing variations.

The application of the present material for toys of the dolls category can be divided into three main types. Firstly, the material might be used as stuffing for toys, secondly as an alternative material for making the whole toy, and thirdly as a material to cover the construction of a joint. For example, an elbow, knee, ankle or knuckle joint in a doll or other toy might be covered with a skin-like surface made from the present material.

Plush toys are normally stuffed with soft cotton or polystyrene fibres, which are non-elastic. The present material with soft elastomeric properties of the much better touch feeling when used as a stuffing material.

The compatibility of the present material with other resins such as colour additives, allows the material to be produced in a wide range of colours. In addition, the material can be used for the manufacture of figurines, animals, land and sea creatures, to name a few.

1. A styrene block copolymer mixed with process mineral oil and including a small amount of antioxidant to reduce surface stickiness upon exposure to air.

2. A method of reducing surface stickiness of an elastic gel material, the method comprising the addition of a small amount of antioxidant during compounding of the elastic gel material.

3. The method of claim 2, further comprising melting the elastic gel material to assist compounding.

4. The method of claim 3, further comprising cooling the compounded gel material to room temperature.

5. The method of claim 2, wherein the elastic gel material is a styrene block copolymer.

6. The method of claim 5, wherein the styrene block copolymer is SEBS.

7. The method of claim 5, wherein the styrene block copolymer is SEEPS.

8. The material of claim 1, wherein the antioxidant is Iranox 1010 produced by Ciba.

9. The method of claim 2, wherein the antioxidant is added into a mixture of the styrene block copolymer and process oil before melting same and cooling to room temperature.

10. The method of claim 2, including forming the compounded material into a desired shape.

11. The method of claim 10, wherein said forming is by means of casting, injection moulding or blow moulding.

12. The method of claim 10, comprising achieving a desired surface texture by appropriate choice of mould material and mould surface finish.

13. The method of claim 2, further comprising exposing the surface of the formed gel material to a well ventilated atmosphere and maintaining an air-flow over the surface.

14. The method of claim 1, wherein the amount of antioxidant added to the other ingredients is from 1.2 to 2.0% by weight.
